(19) United States
(12) Patent Application Publication
(10) Pub. No.: US 2009/0285744 A1
(43) Pub. Date: Nov. 19, 2009

(54) Process For Producing Fine Diamond and Fine Diamond

(75) Inventors: Hideaki Sugihara, Yamaguchi (JP); Haruhiko Kudou, Yamaguchi (JP); Hideomi Sakai, Yamaguchi (JP)

Correspondence Address: Nields, Lemack & Frame, LLC, 176 E. Main Street, Suite #5, Westborough, MA, 01581, US

(73) Assignee: NIPPON KAYAKU KABUSHIKI KAISHA, Chiyoda-ku, Tokyo (JP)

(21) Appl. No.: 11/921,962

(22) PCT Filed: Jun. 28, 2006
(86) PCT No.: PCT/JP2006/312914

§ 371 Date: Dec. 11, 2007

(30) Foreign Application Priority Data
Jun. 29, 2005 (JP) 2005-189897
Jul. 29, 2005 (JP) 2005-219886
Jul. 29, 2005 (JP) 2005-219934

(51) Int. Cl. B01J 3/06

(52) U.S. Cl. 423/446; 149/108.2

(57) ABSTRACT

The present invention relates to a process for producing a fine diamond characterized by that an explosive composition containing a compound having an aliphatic hydrocarbon ring with 4 to 15 carbons, a fullerenes or a tubular or fiber carbon nanostructure having a diameter of 1 to 100 nm as a carbon raw material is exploded for explosive synthesis, and a fine diamond obtained by said process; the ultrafine particulate diamond of 1 to 3 nm is expected, as a single nano diamond, for application of the fields such as ultrafine processing, the uniform, spherical fine particulate diamond of 0.01 to 100 μm is expected as abrasive grains for polishing in precise processing and the like, and the needle diamond is expected for application in various sensors and the like.

### TECHNICAL FIELD

The present invention relates to a process for producing a fine diamond which can be used for abrasive materials, lubricants, surface modifying agents, electronic devices, for example, sensors and the like, and a fine diamond.

### BACKGROUND OF THE INVENTION

Diamonds have the highest hardness among existing substances, so diamond fine particles are, as abrasive grains for grinding wheels, abrasive grains for lapping and polishing, widely used in processes for polishing object surfaces smoothly. In particular, with the recent introduction of new industrial materials and the rapid development of electronic devices, more and more demand for diamonds is apt to increase as polishing abrasive grains for ultrafine processing of these materials. In addition, improvement of lubricity and abrasion resistance of object surfaces by forming a thin film composed of diamond fine particles on object surfaces is practically realized. Further, a diamond is a substance superior not only in such mechanical properties but also in electrical properties, thermal properties and optical properties, and a material expected for use in a wider range of fields. For example, a diamond has characteristics such as very high heat conductivity, transparency in wide wave ranges due to its large band gap and physicochemical stability, and is expected for application in a wide range of fields such as semiconductor devices, electron emission devices, ultraviolet light emitting devices and biosensors.

At the present, for applications in abrasive materials, lubricants, surface modifying agents and the like, single crystalline and polycrystalline diamonds are produced industrially by various production method such as CVD method (see, for example, Patent literature 1 and Patent literature 2), high-temperature high-pressure method (see, for example, Patent literature 3), shock compaction method (see, for example, Patent literature 4 and Patent literature 5) and detonation method (see, for example, Patent literature 6 and Patent literature 7).

In these known production method, methane gas, carbon black, graphite and the like are generally used as carbon raw materials. And the crystal size of diamond to be obtained varies in a wide variety of 5 nm to tens of mm, but any of those forms is particulate and not different largely from each other except for a thin film diamond synthesized by CVD method.

Conventionally, fine particles of diamond synthesized by static high-pressure method are used for most of the diamond abrasive grains. A diamond synthesized by static high-pressure method is a single crystalline diamond, so the particle is angulated and has very sharp angles. Further, due to cleavage which is specific to diamond crystals, particles having sharp angles are liable to be produced by crushing and also large particles are liable to be produced. That's why particles classified into a desired particle size distribution are generally used. Particles having particle sizes out of its rang the distribution are not required, so yield improvement is a challenge. In addition to that, sharp angles are always formed on a particle of such single crystalline diamond during polishing and cut into processed materials so that drawbacks on high smoothness of material surfaces occur, so the particles are not suitable for polishing abrasive grains for fine processing.

On the other hand, in high dynamic pressure method which is a shock compaction method utilizing shock waves, a lot of graphite powder are used as a carbon raw material (see Patent literature 4, Patent literature 5 and Patent literature 9), and fine particles of polycrystalline diamond where a lot of fine crystallites with a diameter of about 5 to tens of nm are bonded (diamond bond) are obtained. The particles synthesized even under the same conditions have so wide a range of particle size that the shapes are indeterminate and the abrasive performance varies largely, so particles classified into a desired particle size distribution are usually used. Particles having particle sizes out of its rang are not required. That's why improvement of yield is a challenge. Further, with the recent performance improvement of precision apparatuses such as electronic devices, requirements for improvement of classifying precision and better processed surface quality are on increase.

With the boom of IT industry, the demand for abrasive materials for final polishing of magnetic heads, hard disks and the like is expanding. Among them, atomization of diamonds for polishing is advanced according to improvement of processing precision of hard disks where high densification and high capacity are proceeding, and it is considered that further atomization will continue to be required. Further, a single nanoparticle of diamond are an object of study in a wide range of other fields, and for example, it is expected that the demand on atomization of diamonds for improvement of filling factor by sharing with particles having conventional sizes in the case of using them as fillers for optical materials or semiconductor sealing materials, enlargement of the surface area in the case of using them as carriers of catalysts and the like, and the like will be expanded in the future.

Under such circumstances, so called single crystalline nano diamond having a particle size of a single nano size can be selectively synthesized by detonation method of synthesizing diamonds where explosive energy of explosion with a negative oxygen balance is directly used and an explosive component is utilized as a carbon source. An average particle size of commercially now available nano diamonds is 4 to 10 nm, but those nano diamonds are strongly agglomerated into clusters (secondary particles) having a size of 50 to 200 nm due to the existence of amorphous carbons which are byproduct during synthesis, which leads to the conditions where the characteristics of single nanoparticles are largely lost. Various attempts are made on purification, deagglomeration and dispersation of nano diamonds in order to shred these clusters into separate single particles, i.e. single nanoparticles (see, for example, Patent literature 8), and it is expected that nano diamonds will surely be useful in various fields as a superior raw material having the original characteristics of single nanoparticles in the near future.

In the detonation method, when graphite, carbon black or the like is, as a carbon raw material, added to explosives for explosive synthesis, micron-sized polycrystalline diamonds are produced in large part.

Patent literature 1: JP 1993-279185 A
Patent literature 2: JP 2004-210559 A
Patent literature 3: JP H04-108532 A
Patent literature 4: JP H06-121923 A
Patent literature 5: JP H06-93995 A
Patent literature 6: JP H06-59398 A
Patent literature 7: JP H07-51220 A
Patent literature 8: JP 2004-238256 A
Patent literature 9: JP H07-75662 B

### DISCLOSURE OF THE INVENTION

### Problems to be Solved by the Invention

From such circumstances, selective synthesis of non-angular spherical polycrystalline diamonds with small size variation which is suitable for polishing and the like, needle polycrystalline diamonds suitable for application for various minute sensors and the like, and ultrafine particulate single crystalline diamonds where the average particle size is smaller than that of conventional nano diamonds, and the like are required.

### Means of Solving the Problems

The inventors of the present invention have intensively studied a way to efficiently synthesize various diamonds satisfying the above requirements to find that a spherical polycrystalline diamond, a needle polycrystalline diamond and an ultrafine particulate single crystalline diamond (diamond having single crystalline particles of smaller than 4 nano, preferably no more than 3 and no less than 1 nano) can be obtained by formulating a specific carbon raw material as a carbon source in detonation method, and completed the present invention.

That is, it has been found that an ultrafine particulate single crystalline diamond having an average particle size smaller than that of conventional diamonds can be obtained by explosive synthesis of an explosive composition formulated with a compound having an aliphatic hydrocarbon ring with 4 to 15 carbons, a polycrystalline particulate diamond of a sphere of finite form is selectively synthesized by detonating an explosive composition where a fullerenes is formulated as a carbon raw material, and that a needle polycrystalline diamond is selectively synthesized by detonating an explosive composition where a tubular or fiber carbon nanostructure having a diameter of 1 to 100 nm is formulated as a carbon raw material, and the present invention has been completed.

That is, the present invention relates to:

(1) A process for producing a fine diamond, characterized by that explosive synthesis is conducted by exploding an explosive composition containing a compound having an aliphatic hydrocarbon ring with 4 to 15 carbons, a fullerenes or a tubular or fiber carbon nanostructure having a diameter of 1 to 100 nm, as a carbon raw material,
(2) The process for producing a fine diamond according to the above (1), characterized by that the compound having an aliphatic hydrocarbon ring with 4 to 15 carbons is an adamantanes,
(3) The process for producing a fine diamond according to the above (1), wherein the carbon nanostructure is a carbon nanotube.
(4) A fine diamond obtained by explosive synthesis of an explosive composition where an adamantanes, a fullerenes or a carbon nanotube is formulated as a carbon raw material,
(5) A diamond having a single crystalline particle size of 1 to 3 nm,
(6) A fine diamond having a particle size of 0.01 to 100 μm, wherein the fine diamond is a sphere of finite form,
(7) The fine diamond according to the above (6), which is a polycrystalline diamond,
(8) The fine diamond according to the above (4), which is a needle polycrystalline diamond having a diameter of 1 to 100 nm,
(9) The fine diamond according to the above (8), wherein the ratio of length/diameter is not less than 10,
(10) The process for producing a fine diamond according to the above (1), wherein the explosive component of the explosive composition is a compound containing a nitro group,
(11) The process for producing a fine diamond according to the above (10), wherein the addition ratio of the carbon raw material is 1 to 10% by weight based on the explosive composition (hereinafter, the same unless otherwise specified),
(12) An explosive composition characterized by comprising a compound having an aliphatic hydrocarbon ring with 4 to 15 carbons, a fulleren or a tubular or fiber carbon nanostructure having a diameter of 1 to 100 nm,
(13) The explosive composition according to the above (12), characterized by that the compound having an aliphatic hydrocarbon ring with 4 to 15 carbons is an adamantanes,
(14) The explosive composition according to the above aspect (12), wherein the tubular or fiber carbon nanostructure having a diameter of 1 to 100 nm is a carbon nanotube.

### EFFECT OF THE INVENTION

The fine diamond of the present invention exhibits excellent mechanical, thermal, electric and optical properties which diamonds have, or properties as a single nano particle or the like, more effectively compared with conventional diamonds. For example, the ultrafine particulate diamonds are useful as polishing abrasive grains or fillers for ultrafine processing and the like, the non-angular spherical polycrystalline diamonds with small size variation are suitable for polishing and the like and useful as abrasive grains for grinding wheels and abrasive grains for lapping and polishing, and the needle polycrystalline diamonds are expected as various sensor needles. In addition, the present invention can provide the fine diamonds depending on the shape of a compound having an aliphatic hydrocarbon ring, a fullerenes or a carbon nanostructure to be added as a carbon raw material, at a high yield.

### BRIEF DESCRIPTION OF THE DRAWINGS

FIG. 1 X-ray diffraction spectrum of diamond powders obtained in Example A1 and Comparative Example A1

FIG. 2 A scanning electron microscope (SEM) photograph of diamond powder obtained in Comparative Examples B1

FIG. 3 A SEM photograph of diamond powder obtained in Example B1

FIG. 4 A field emission scanning electron microscope (FE-SEM) photograph of diamond powder obtained in Example B2

FIG. 5 A SEM photograph of diamond powder obtained in Comparative Example C1

FIG. 6 An FE-SEM photograph of diamond powder obtained in Example C1

### BEST MODE FOR CARRYING OUT THE INVENTION

Hereinafter, the present invention will be described specifically.

The term “a polycrystalline diamond” or “a polycrystallisation” mentioned in the present invention means a substance formed by diamond bond of a lot of fine crystallites.

The ultrafine particulate single crystalline diamond, the spherical polycrystalline diamond or the needle polycrystalline diamond of the present invention can be synthesized by detonating, typically in a closed vessel, water or the like, an explosive composition where a compound having an aliphatic hydrocarbon ring with 4 to 15 carbons (preferably an adamantanes), a fullerenes or a carbon nanostructure, preferably a carbon nanotube, is mixed as a carbon raw material. The explosion can be detonated with a detonator and the like, similarly to an explosion of typical explosives. The size of the closed vessel is not particularly limited, but preferably, for example, based on 100 to 200 g of an explosive, an about 5 to 50 liter, more preferably about 10 to 30 liter vessels which can resist the explosion in view of easiness in collecting synthesized diamonds and the like.

The explosive component of the explosive composition in the present invention preferably has a detonation velocity of no less than 7000 m/s, and one currently used in general has a detonation velocity of about no more than 9000 m/s. Said explosive component includes a compound containing a nitro group, preferably a compound containing no less than 3 nitro groups, for example, a aromatic nitro compound (preferably tri- or tetra-nitrobenzene which may be substituted by an amino group or/and a methyl group), nitroamine (preferably C3 to C6 alkyl (3 to 6 nitro) amine) and nitrate ester. Its specific examples include TNT (trinitrotoluene), tetryl (tetranitromethylaniline), RDX (trimethylene trinitroamine), HMX (tetramethylene tetranitroamine), PETN (pentaerythritol tetranitrate) and the like. These are used alone or in mixture of two or more thereof. As a matter of course, explosives for other industries can be also used as long as they can give an explosion impact pressure required for producing diamonds.

The explosive component of the explosive composition in the present invention is 80 to 99% (by weight) (hereinafter, the same unless otherwise specified), preferably 85 to 99%, and more preferably 90 to 99%, based on the whole explosive composition. In addition, a compound having an aliphatic hydrocarbon ring with 4 to 15 carbons (preferably an adamantanes), a fullerenes or a carbon nanotube to be mixed as a carbon raw material of diamond is 1 to 20%, preferably 1 to 15%, and more preferably 1 to 10%, based on the whole explosive composition. When the formulation amount is smaller, no problem is posed on the fine diamond synthesis per se but a yield obtained at a time is smaller. On the other hand, when the formulation amount of said carbon raw material is larger, the explosive power may be affected.

The explosive composition to be used for synthesis of the fine diamond of the present invention is produced by melting an explosive component and adding the above carbon raw material thereto followed by mixing uniformly. Melting an explosive component may be conducted by any method, but preferably by a heat melting method of an explosive component typically with water or oil such as glycerin as a heating medium. The heating temperature is not particularly limited as long as the explosive component can be safely melted. Typically it is about 90 to 100° C. Mixing of a carbon raw material into the melt liquid may be conducted by any method as long as the carbon raw material can be mixed uniformly in the melt liquid. In general, the mixing is conducted typically by an agitator. An explosive composition to be used in the present invention is preferably molded, in the way that the explosive composition in the melt state is melt-loaded into a molding vessel for molding. The shape of the molded article is not limited, but usually a square or circular molded article is used.

For synthesizing the fine diamond according to the process of the present invention, the above obtained explosive composition of the present invention containing the carbon raw material, preferably the above molded article, can be exploded in a suitable closed vessel which can resist explosion, for example an explosion chamber and the like, or in water, to produce a diamond by explosive synthesis. More specifically, a detonator is placed on the above obtained explosive composition of the present invention, preferably the above molded article, which is set in an explosion chamber, preferably in the center thereof, if required, the air inside thereof is replaced with inert gas (for example, nitrogen, argon, carbon dioxide or the like), the vessel is closed, and then the explosive composition is exploded by detonation with a detonator to produce diamonds by explosive synthesis. In the case of explosion in water, an appropriate amount of water is put in a suitable vessel, where the explosive composition of the present invention is exploded in it similarly above.

Typically, after the explosion, the explosion products are collected as water slurry and like by treatment such as washing the inside of the vessel with water. After the collected water slurry is allowed to stand to separate the precipitate, in order to remove metals, amorphous carbons and the like mixed in the explosion product, acid treatment which is a typical method for diamond purification is conducted to remove the metals, and if required, heating treatment is conducted at a temperature of about 400° C. or treatment by mixed acid of concentrated nitric acid and concentrated sulfuric acid is conducted to remove amorphous carbons and the like, followed by washing with water and drying to obtain the fine diamond of the present invention.

By the thought that the fine diamond of the present invention is synthesized from the added carbon raw material, the fine diamond is synthesized at a yield of about 50 to 75% based on the added carbon raw material, in the present invention.

Subsequently, the synthesis of the ultrafine particulate single crystalline diamond of the present invention will be explained more specifically.

The carbon raw material to be formulated in the explosive composition in the synthesis of the ultrafine particulate single crystalline diamond of the present invention includes compounds having an aliphatic hydrocarbon ring, for example, cycloalkanes such as cyclohexanol, cyclopentanone and dimethylcyclohexane, cycloalkenes such as dicyclopentadiene and norbornene monomer and adamantanes such as adamantane and adamantanol, preferably compounds having an aliphatic hydrocarbon ring with 4 to 15 carbons (hereinafter optionally, also referred to as said aliphatic hydrocarbon ring compound). Among these compounds, adamantanes are particularly preferred for the synthesis of the ultrafine particulate single crystalline diamond because their melting points, boiling points and flash points are high and they become solid at an ordinary temperature after mixing with an explosive component. The adamantanes can include adamantane, homologs thereof, adamantane derivatives and the like, and the adamantane derivatives can include adamantane derivatives having 1 to 2 substituents with a molecular weight of 15 to 200, preferably about 15 to 100. Any of the above adamantanes can be used in the present invention. Said substituents can include a hydroxy group, an amino group, a carboxyl group, or those groups substituted by a C1 to C10, preferably C1 to C5 carbon hydride residue, or a halogen atom, or a C1 to C10 carbon hydride residue or the like.

In the synthesis of the ultrafine particulate single crystalline diamond of present invention, the amount of said aliphatic hydrocarbon ring compound, preferably an adamantanes, to be used for formulation of the explosive composition varies depending on the kind of explosive component to be used, but is typically 1 to 10%, preferably 2 to 6%, and optionally, more preferably 2 to 4%, based on the whole explosive composition. In this case, the rest is usually an explosive component.

The ultrafine particulate single crystalline diamond of the present invention has a characteristic that the single crystalline particle thereof is further smaller than that of a nano diamond obtained by a conventional detonation method where an explosive component is utilized or graphite or the like is added, as a carbon raw material. Said ultrafine particulate single crystalline diamond is obtained typically in the state where single crystalline particles are agglomerated, and if required, this aggregate can be made in the state of single crystalline particles by a known method of dispersing it in water and the like and then subjecting to supersonic treatment.

As a result of X-ray diffraction (radiation source: CuK α line, tube voltage: 40 kV, tube current: 30 mA) on the ultrafine particulate single crystalline diamond obtained by the present invention, the size of the diamond crystallite (single crystalline particle) of the present invention was determined by calculation from the broadening in width of the diffraction line based on Scherrer formula (Hiroaki Yanagida Ed., “Engineering System for Fine Particles” Part-1, p. 333, 2002, Fujitec System). The size is within the range of 1 to 3 nm and much smaller than a conventional one of 5 nm. There has never been such a case that such ultrafine particulate diamond is actually synthesized, and the present invention can provide it for the first time.

By the present invention, ultrafine particulate single crystalline diamonds having a size of 1 to 3 nm can be obtained as the main component, and they account for at least no less than 50%, preferably 60% to 100%, and more preferably 70 to 100%. From the observation by using a field emission scanning electron microscope, it is considered that the above component accounts for 80 to 100%.

In this regard, the term “the size of a single crystalline particle of the ultrafine particulate diamond” mentioned in the present invention means, unless otherwise specified, a size determined from broadening in width of the spectrum (diffraction line) of the result from X-ray diffraction as described above.

Next, the fine diamond synthesis by using the explosive composition where a fullerenes is formulated as a carbon raw material in the present invention will be explained more specifically.

The fullerenes to be used in the present invention is not particularly limited as long as it is generally classified to fullerenes. That is, any of fullerenes having a hollow shell carbon molecule closed by a network of 5 membered rings and 6 membered rings can be used. The preferable specific examples of the fullerenes include C60, C70, C84 and the like, which can be used alone or in mixture of two or more thereof according to need. The content of the fullerenes in the explosive composition differs depending on the kind of an explosive component to be used, but is generally in the range of 1 to 10%, preferably 1 to 8%, and more preferably 2 to 6%, based on the whole explosive composition. Optionally, optimal is about 1 to 7% based on the whole explosive composition.

Explosive synthesis of the explosive composition where a fullerenes is formulated as a carbon raw material and isolation of synthesized diamonds can be carried out by the foregoing method.

The particle size of the obtained fine diamond varies widely depending to the amount of the fullerenes to be added, the kind of the fullerenes and the like so it is not necessarily appropriate to suggest, but seen from the experiment results of C 60, when the amount to be added is larger, for example, spherical particles having no angulis and a particle size of 10 to 50 nm account for about 90 to 99% of the diamond powder obtained by adding C 60 at the ratio of about 5% based on the explosive composition, according to observation by a field emission scanning electron microscope; and when the amount to be added is smaller (for example, when the amount of C 60 to be added is about 2% based on the explosive composition), the particles are spherical polycrystallisation having the unit of micron and uniformly have a particle size of 1 to 2 μm according to observation by a scanning electron microscope, and spherical polycrystalline diamonds having a particle size of 1 to 2 μm comprise about 90 to 99% at a ratio by weight.

From the above result, the fine diamond subjected to explosive synthesis using explosive composition containing a fullerenes as a carbon raw material can has polycrystalline diamonds whose polycrystalline has a size which can be controlled in a wide range of about 10 nm to about 2 μm by the amount to be added and a well-uniformed constant spherical configuration. Accordingly, the fine diamonds of the present invention has a possibility to be utilized as abrasive grains for ultrafine polishing which is required to provide finer finished surface properties.

And, by the thought that these polycrystalline diamonds are synthesized from a fullerenes, the fine diamonds of the present invention can be obtained at a high yield of 50 to 75% when the fullerenes is added at a ratio of 2 to 5% based on the whole explosive composition.

Next, the fine diamond synthesis, in the present invention, by using an explosive composition where a tubular or fiber carbon nanostructure having a diameter of 1 to 100 nm, preferably a carbon nanotube, is formulated as a carbon raw material will be explained more specifically.

The above carbon nanostructure to be used in the present invention is not particularly limited as long as within the above range. Said carbon nanostructure preferably has no less than 10 of an L/D (the ratio of length/diameter), and a needle diamond can be obtained by use of such nanostructure. Specific examples of said carbon nanostructure include nanografibers, carbon nanotubes, carbon nanohorns and the like, preferably carbon nanotubes. Further, a carbon nanotube having an L/D (the ratio of length/diameter) of no less than 10 is preferable. In the fine diamond of the present invention, the shape and size of the carbon nanotube used as a raw material are reproduced almost as they are. That is, needle-shaped ones are selectively synthesized.

In synthesis of the fine diamond of the present invention, the amount of a carbon raw material to be used for formulation of an explosive composition varies depending on the kind of an explosive component to be used, but usually is in the range of 1 to 10%, preferably 2 to 6%, of the whole explosive composition.

Explosive synthesis from an explosive composition containing a carbon nanostructure and isolation of a synthesized diamond can be carried out according to the above description.

The obtained fine diamond was observed by a field emission scanning electron microscope, and it was composed of polycrystalline where a lot of needle fine crystallites having a minor axis of 5 to 10 nm are bonded and the main component was a needle polycrystallisation having a diameter (minor axis) of 50 to 150 nm and a length (major axis) of 0.3 to 1.5 μm. Said needle polycrystallisation was observed to be almost about 50 to 99%, more preferably 80 to 99%.

And, by the thought that these needle diamonds are synthesized from said carbon nanostructures, the needle diamonds of the present invention can be obtained at a high yield of 60% when said carbon nanostructure is added at a ratio of 5% based on the whole explosive composition.

### EXAMPLES

The present invention will be explained more specifically by Examples, but the present invention is not limited only to these Examples.

### Examples A1

After 100 g of pentolite composed of 50% of TNT and 50% of PETN was melted in a melt bath heated with water vapor, 3 g of adamantanediol was added thereto, stirred with an agitator to blend, followed by melt loading in a molding vessel to obtain 103 g of a molded article of explosive composition. This is placed in an explosion chamber with an internal space of 15 L, and the explosive composition was exploded by a 6 sized detonator. After the explosion, the gas inside the explosion chamber was exhausted, the inside of the explosion chamber was washed with water, and solid explosion products were collected in slurry and allowed to stand. The precipitation was separated, metals such as fragments of the detonator were removed by hydrochloric acid treatment, the soot was removed by a mixed acid of concentrated nitric acid and concentrated sulfuric acid, and then the precipitation was washed with water and dried. As the result, light grey diamond powder was obtained at a yield of 2% based on the explosive composition.

### Comparative Example A1

In the same manner as in Example A1, 100 g of pentolite composed of 50% of TNT and 50% of PETN was melt-loaded in a melt bath to obtained 100 g of a molded article of explosive composition. This was, in the same manner as in Example A1, exploded in an explosion chamber with an internal space of 15 L. Hereinafter, by conducting the same treatment as in Example A1, light grey diamond powder was obtained at a yield of 1.5% based on the explosive composition.

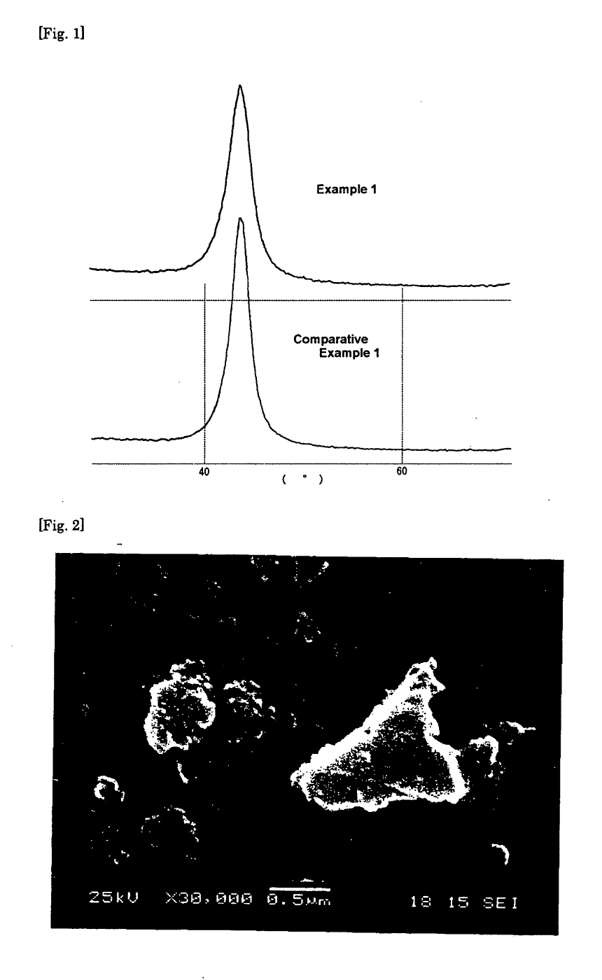

The light grey diamond powders obtained in Example A1 and Comparative Example A1 were observed using a field emission scanning electron microscope, and it is verified that the diamond powder in Comparative Example A1 was composed of particles of 4 to 6 nm and secondary particles of agglomerates thereof, but that the diamond powder in Example A1 was composed of ultrafine nanoparticles (considered to be single crystals) of 1 to 3 nm and secondary agglomerate particles thereof. And as a result of X-ray diffraction (radiation source: CuK α line, tube voltage: 40 kV, tube current: 30 mA), the sizes of the crystallites (single crystalline particles) were determined by calculation from the broadening in width of the diffraction line based on Scherrer formula. The size of the crystallite of the diamond powder in Comparative Example A1 was 5 nm and the size of the crystallite of the diamond powder in Example A1 was 2 nm. The X-ray diffraction spectrums of Comparative Example A1 (lower) and Example A1 (upper) are shown in FIG. 1.

### Example B1

After 100 g of pentolite composed of 50% of TNT and 50% of PETN was melted in a melt bath heated with water vapor, 2 g of C60 which is 2% based on the pentolite was added thereto, stirred with an agitator to blend, followed by melt loading in a molding vessel to obtain 102 g of a molded article of explosive composition. This is placed in an explosion chamber with an internal space of 15 L, and the explosive composition was exploded by a 6 sized detonator. After the explosion, the gas inside the explosion chamber was exhausted, the inside of the explosion chamber was washed with water, and explosion products were collected in slurry and allowed to stand. The precipitated explosion product was separated, metals such as fragments of the detonator were removed by hydrochloric acid treatment, the soot was removed by a mixed acid of concentrated nitric acid and concentrated sulfuric acid, and then the precipitation was washed with water and dried. As the result, the diamond powder of the present invention was obtained at a conversion ratio of 75% based on the C60.

### Example B2

After 100 g of cyclotol composed of 40% of TNT and 60% of RDX was melted in a melt bath heated with water vapor, 5 g of C60 which is 5% based on the cyclotol was added thereto, stirred with an agitator to blend, followed by melt loading in a molding vessel to obtain 105 g of a molded article of explosive composition. This was, in the same manner as in Example B1, exploded in an explosion chamber with an internal space of 15 L. Hereinafter, the same treatments as in Example B1 were carried out to obtain the diamond powder of the present invention at a conversion ratio of 50% based on the C60.

### Comparative Example B1

After 100 g of the same pentolite as in Example B1 was melted in a melt bath heated with water vapor, 5 g of graphite powder which is 5% based on the pentolite was added thereto, stirred with an agitator to blend, followed by melt loading in a molding vessel to obtain 105 g of a molded article of explosive composition. This was, in the same manner as in Example B1, exploded in an explosion chamber with an internal space of 15 L. Hereinafter, the same treatments as in Example B1 were carried out to obtain diamond powder for comparison at a conversion ratio of 20% based on the graphite powder.

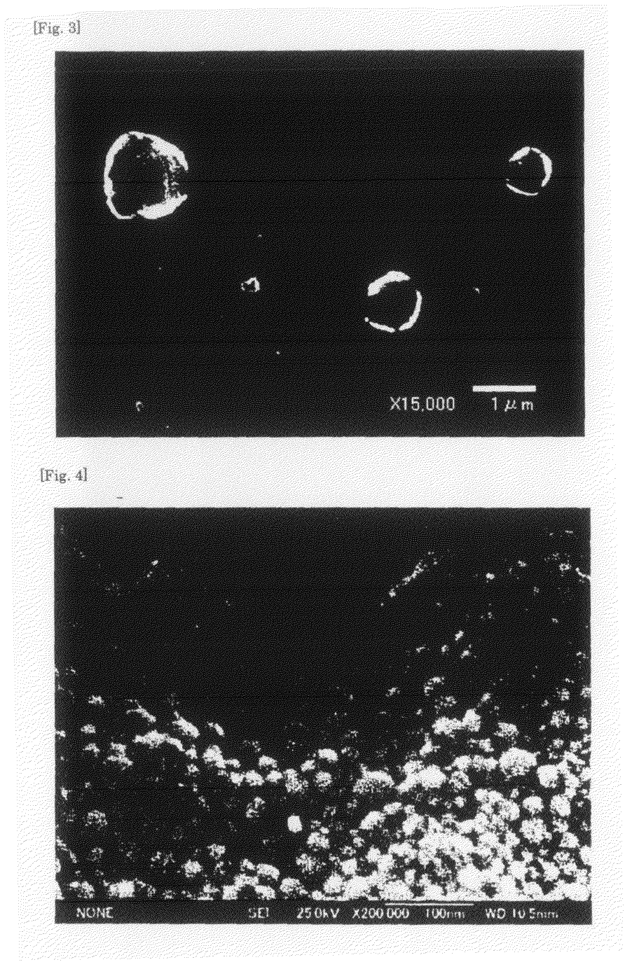

The light grey diamond powders obtained in Example B1, Example B2 and Comparative Example B1 were observed by a scanning electron microscope and a field emission scanning electron microscope, and it was verified that the diamond powder of Comparative Example B1 was composed of fine polycrystalline particles having largely different particle sizes and various forms and secondary agglomerates thereof, and that the diamond powder of Example B1 was composed of fine polycrystalline having a uniform particle size of 1 to 2 μm as well as a non-angular constant form. The scanning electron microscope photograph of the diamond powder of Comparative Example B1 is shown in FIG. 2 and the scanning electron microscope photograph of the diamond powder of Example B1 is shown in FIG. 3. In addition, it was verified that the diamond powder of Example B2 was also composed of highly fine polycrystalline particles having a spherical configuration with a particle size of 10 to 50 nm. The field emission scanning electron microscope photograph of the diamond powder of Example B2 is shown in FIG. 4.

### Example C1

After 100 g of pentolite composed of 50% of TNT and 50% of PETN was melted in a melt bath heated with water vapor, 5 g of carbon nanotube which is 5% based on the pentolite was added thereto, stirred with an agitator to blend, followed by melt loading in a molding vessel to obtain 105 g of a molded article of explosive composition. This was placed in an explosion chamber with an internal space of 15 L, and the explosive composition was exploded by a 6 sized detonator. After the explosion, the gas inside the explosion chamber was exhausted, the inside of the explosion chamber was washed with water, and the explosion products were collected in slurry and allowed to stand. The precipitation was separated, metals such as fragments of the detonator were removed by hydrochloric acid treatment, the soot was removed by a mixed acid of concentrated nitric acid and concentrated sulfuric acid and then the precipitation was washed with water and dried. As the result, the diamond powder of the present invention was obtained at a yield of 3% based on the explosive composition.

### Comparative Example C1

After 100 g of pentolite composed of 50% of TNT and 50% of PETN was melted in a melt bath heated with water vapor, 5 g of carbon black which is 5% based on the pentolite was added thereto, stirred with an agitator to blend, followed by melt loading in a molding vessel to obtain 105 g of a molded article of explosive composition. This was, in the same manner as in Example C1, exploded in an explosion chamber with an internal space of 15 L. Hereinafter, the same treatments as in Example C1 were carried out to obtain diamond powder for comparison at a yield of 2% based on the explosive composition.

The light grey diamond powders obtained in Example C1 and Comparative Example C1 were observed by a field emission scanning electron microscope and a scanning electron microscope, and it was verified that the diamond powder of Comparative Example C1 was composed of fine particulate polycrystallisation having a diameter of 50 to 500 nm, and that the diamond powder of Example C1 was composed of fine needle polycrystallisation where a lot of crystallites having a diameter (minor axis) of 5 to 10 nm and a length of about ten times the diameter were bonded and said polycrystallisation has a diameter of (minor axis) of 50 to 150 nm and a length (major axis) of about 0.3 to 1.5 μm. From these observations by electron microscopes, it is considered that a needle polycrystallisation is the main component of the obtained diamond powder and accounts for nearly no less than 80%.

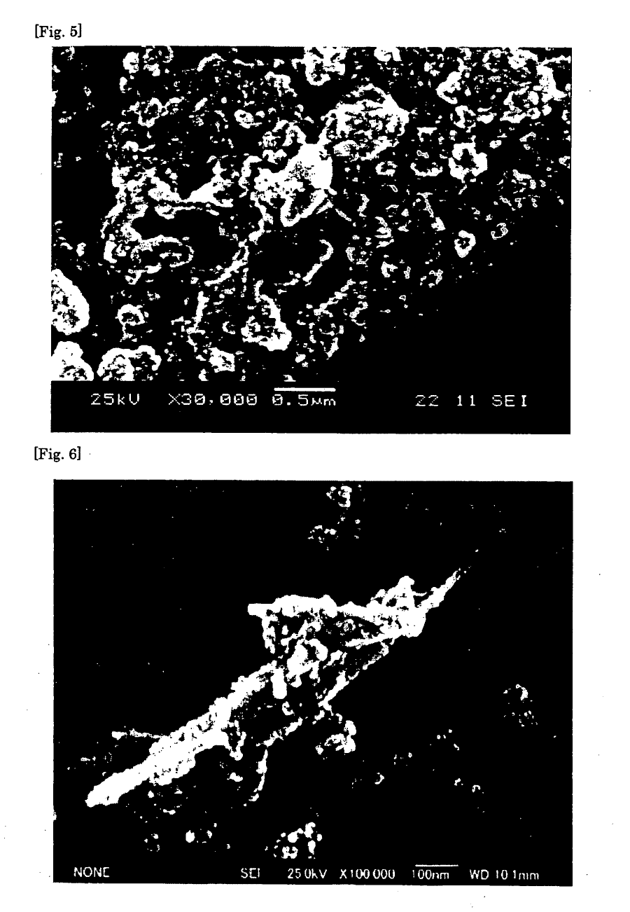

The scanning electron microscope photograph of the diamond powder obtained in Comparative Example C1 is shown in FIG. 5 and the field emission scanning electron microscope photograph of the light grey diamond powder obtained in Example C1 is shown FIG. 6.

### INDUSTRIAL APPLICABILITY

The present invention can provide fine diamonds according to the shapes of an aliphatic hydrocarbon ring compound, a fullerenes or a carbon nanostructure to be added as a carbon raw material at a high yield, the ultrafine particulate diamond obtained by the present invention is useful for polishing abrasive grains for ultrafine processing and the like, the non-angular spherical diamond with the small size variation is suitable for polishing and useful for abrasive grains for grinding wheels or for abrasive grains for lapping and polishing and the like, and the needle crystalline diamond is expected for various sensor needles and the like.

1. A process for producing a fine diamond, characterized by that explosive synthesis is conducted by exploding an explosive composition containing a compound having an aliphatic hydrocarbon ring with 4 to 15 carbons, a fullerenes or a tubular or fiber carbon nanostructure having a diameter of 1 to 100 nm, as a carbon raw material.

2. The process for producing a fine diamond according to claim 1, characterized by that the compound having an aliphatic hydrocarbon ring with 4 to 15 carbons is an adamantanes.

3. The process for producing a fine diamond according to claim 1, wherein the carbon nanostructure is a carbon nanotube.

4. A fine diamond obtained by explosive synthesis of an explosive composition where an adamantanes, a fullerenes or a carbon nanotube is formulated as a carbon raw material.

5. A diamond having a crystallite size of 1 to 3 nm.

6. A fine diamond having a particle size of 0.01 to 100 μm, wherein the fine diamond is a sphere of finite form.

7. The fine diamond according to claim 6, which is a polycrystalline diamond.

8. The fine diamond according to claim 4, which is a needle crystal having a diameter of 1 to 100 nm.

9. The fine diamond according to claim 8, wherein the ratio of length/diameter is not less than 10.

10. The process for producing a fine diamond according to claim 1, wherein the explosive component of the explosive composition is a compound comprising a nitro group.

11. The process for producing a fine diamond according to claim 10, wherein the addition ratio of the carbon raw material is 1 to 10% based on the explosive composition.

12. An explosive composition characterized by comprising a compound having an aliphatic hydrocarbon ring with 4 to 15 carbons, a fullerenes or a tubular or fiber carbon nanostructure having a diameter of 1 to 100 nm.

13. The explosive composition according to claim 12, characterized by that the compound having an aliphatic hydrocarbon ring with 4 to 15 carbons is an adamantanes.

14. The explosive composition according to claim 12, wherein the tubular or fiber carbon nanostructure having a diameter of 1 to 100 nm is a carbon nanotube.
